(19) United States
(12) Patent Application Publication
(10) Pub. No.: US 2013/0063602 A1
(43) Pub. Date: Mar. 14, 2013

(54) SYSTEM AND METHOD FOR REMOTE MONITORING OF EQUIPMENT MOISTURE EXPOSURE

(71) Applicant: Bruce Scapier, New York, NY (US)

(72) Inventor: Bruce Scapier, New York, NY (US)

(21) Appl. No.: 13/230,235

(22) Filed: Sep. 12, 2011

(51) Int. Cl. H04N 7/18; G08C 15/06

(52) U.S. Cl. 348/160; 340/870.02; 348/E07.085

(57) ABSTRACT

The presented principles are directed to an apparatus for monitoring humidity exposure of system components, with the apparatus having sensor modules for collecting environmental data and a monitoring module with a humidity indicator and an electrical monitoring component sealed from the environment that reads a physical change in the humidity indicator to determine the humidity of the environment. An installation computer may transmit the humidity data and sensor readings, wirelessly or otherwise, to a central monitoring station for processing and storage. The humidity indicator may be disposed within an enclosure to determine the humidity within that enclosure. The humidity indicator may also be a desiccant that changes color cased on the humidity, and the electrical monitoring component may be a camera configured to take video data of the desiccant.

### FIELD OF THE INVENTION

The present principles generally relate to remotely monitoring the condition of electronic equipment. More specifically, the present principles refer to a system and method for remotely monitoring the moisture exposure electrical equipment experiences by tracking the moisture content of a desiccant at the electronic equipment. The system comprises a system for taking readings of the moisture content of the desiccant and transmitting the moisture reading to a central monitoring station. The system may permit a user to review data on the moisture content of a desiccant at a particular location to determine the overall moisture that electronics at a particular location have been exposed to for a particular reading, or over a period of time.

### BACKGROUND

Moisture is a well known problem for electrical systems. The first issue with moisture and electrical systems is that water may short out an electrical circuit. However, another problem caused by moisture is corrosion. Electrical systems in outdoor or non sheltered installations are particularly exposed to conditions that tend to cause physical defects in the system. For example, extreme temperature fluctuations, extremes in humidity, water intrusion, fouling by debris and being disturbed by animals are just a few of the problems that can affect an electrical system deployed outdoors.

When an electrical system is deployed in a remote location, access is generally limited by the remoteness of that location, and so an electrical system tends to lack regular examination and maintenance. When combining a lack of maintenance with an outdoor installation, electrical systems can suffer a high failure rate.

Ideally, a completely sealed electrical system would offer protection against the elements and presumably, a longer service life for the system. However, as a practical matter, an electrical system cannot be completely sealed because the system needs maintenance, updating, repair and the like. Most electrical systems require plugs, cabling interconnections or access panels that offer openings for moisture or other adulterants to corrode or interfere with the electrical system. Permitting moisture in the form of humidity or liquids to contact the metal conductors of the electrical system can cause the metal circuits to corrode and eventually fail. Even well known conductors like aluminum, tin, lead, copper, and related alloys can oxidize when exposed to liquids. And galvanic corrosion is a well known issue that arises when dissimilar metals are able to exchange ions via direct contact or a liquid pathway. This can particularly be a problem where connectors, cables, wires, traces, solder joints and the like are made from different metals and are exposed to moisture. Systems for sheltering the electrical system from the elements can offer some respite from the water and prolong the useful life of an electrical system, but even with such enclosures, the electrical system will still fail at some point.

Another issue with such electrical system installations is condensation. Many sheltered units are sheltered form major events but the shelters are not hermetically sealed units. For example, a concrete or metal shed type enclosure may be used to house an electrical system where the components of the electrical system have their own enclosures. In particularly useful embodiments, the component enclosures may be rated for protection against, for example, debris, dirt, rain, sleet or snow, splashed or sprayed water, dust and ice. Enclosures rated as NEMA 4 compliant or better may be advantageously employed as component enclosures to aid in protecting components against liquids and solid objects. Additionally, the physical installation of electrical components and connectors may be configured to help prevent the migration of water and damage to electrical systems. For example, installing a “U bend” or loop in cabling just before a connection provides a point lower on the cable than the connector and permits water to run off of a cable to prevent entry of water into a connector. The shed or component enclosure may protect the electrical system from snow, hail leaves and the like, but it cannot practically be sealed against changes in temperature or humidity. It is the changes in temperature and humidity that lead to problems with condensation and the introduction of moisture within the electrical system's component housings. Other avenues for moisture intrusion may include plug openings, the interior of cabling, imperfect or deteriorating seals and thermal expansion and contraction of sealed gases or enclosure components.

Instead of attempting to prevent the failure of the electrical system indefinitely, it may be advantageous to monitor the condition of the electrical system and provide maintenance and replacement of parts prior to actual failure. Ideally, maintenance would take place prior to any failure of the system so that the system may be kept up and running as consistently as possible.

Monitoring the humidity a particular system installation has been exposed to is one method for determining the exposure over time that a particular piece of equipment has been exposed to. Attempts to monitor the conditions have been made by electronic humidity sensors but with little long term success. The issue with electronic humidity sensors is that the humidity sensing element must remain exposed to the elements and is prone to corrosion itself. This sensing element corrosion also tends to occur faster than most other electrical system components because the sensor has no protection from the elements, while other electrical system components have some sheathing or enclosure based protection. This difference in weather protection tends to cause the humidity sensor to corrode and fail faster than other, more protected electrical components.

Other attempts to use non-electrical humidity sensors include desiccant humidity indicators that change color depending on the humidity level. For example, cobalt chloride turns from blue to purple to pink depending on the humidity level and resulting waters saturation of the desiccant. Similarly, copper chloride turns from brown or yellow to blue depending on its moisture saturation level. Common uses of desiccant humidity indicators are desiccant plugs for large volumes spaces or desiccant humidity indicator cards for small volume or sealed spaces. The advantage of a desiccant style humidity indicator is that the indicator will show the current humidity at a given time because the desiccant can vary its color when the humidity rises or falls. In contrast, maximum humidity indicators may have a crystalline chemical that “melts” or runs on a card or surface once the humidity in a space reaches a certain point. That process is not reversible, and so a user can determine whether the humidity in that space exceeded some predetermined amount in any given time.

The disadvantage to a chemical indicator such as a desiccant is that a user must observe the desiccant's color at a particular time to determine the instantaneous humidity level. The desiccants have a longer useful life than an electrical sensor, but must be physically observed. Without some method of transmitting the humidity data to a central monitoring station, the individual installation sites must be visited manually to review the state of the desiccant at each installation.

### SUMMARY OF THE INVENTION

The presented principles are directed to an apparatus for monitoring humidity exposure of system components, with the apparatus having sensor modules for collecting environmental data and a monitoring module with a humidity indicator and an electrical monitoring component sealed from the environment that reads a physical change in the humidity indicator to determine the humidity of the environment. An installation computer may transmit the humidity data and sensor readings to a central monitoring station for processing and storage. The apparatus may further include an antenna for wireless transmissions and/or a modem for handling one or more data streams. The humidity indicator may be disposed within an enclosure to determine the humidity within that enclosure. The sensors may be installed outside of the enclosure to permit measurements of data in the environment outside of the system's enclosure.

In some embodiments, the humidity indicator may be a desiccant that changes color cased on the humidity, and the electrical monitoring component may be a camera configured to take video data of the desiccant. The desiccant may be embedded in a card with printed registration marks or a color comparison indicator for compensating for atmospheric condition and determining the desiccant color and humidity value. The camera may further include lights for illuminating the desiccant and/or lens filters for clarifying the video image data read from the desiccant.

Some embodiments may also have the installation computer configured to take sensor or humidity readings automatically at predetermined intervals, or in response to a command form an outside source.

Sensor modules may be for measuring rainfall, measuring a seismic event, measuring a water level, measuring temperature, measuring wind speed, measuring barometric pressure, detecting motion, generating environmental video data, generating environmental sound data, measuring biological components, measuring salinity, measuring chemical concentrations, measuring environmental contamination, measuring a radiation level, and detecting tampering system components.

### BRIEF DESCRIPTION OF THE DRAWINGS

A further understanding of the present principles can be obtained by reference to a preferred embodiment, along with alternative embodiments, set forth in the accompanying drawings where like reference numbers indicate like elements throughout the drawings. Although the illustrated embodiments are merely exemplary of systems for carrying out the present principles, the organization and method of operation of the principles in general, together with further objectives and advantages thereof, may be more easily understood by reference to the drawings and the following description. The drawings are not intended to limit the scope of the principles, which is set forth with particularity in the claims as appended or as subsequently amended, but merely to clarify and exemplify the principles.

For a more complete understanding of the present principles, reference is now made to the following figures:

FIG. 1 is a diagram illustrating an embodiment of an installation for a remote station with remote humidity exposure monitoring.

FIG. 2 is a diagram illustrating one embodiment of a monitoring module.

FIG. 3 is a diagram illustrating a central monitoring station system for handling and analyzing data from a plurality of remote stations.

FIG. 4 is a diagram illustrating the process of the data management module handling data exchange.

### DETAILED DESCRIPTION

Illustrative embodiments of the present principles are disclosed herein. However, techniques, systems and operating structures in accordance with the present principles may be embodied in a wide variety of forms and modes, some of which may be different from those in the disclosed embodiment. Consequently, the specific functional details disclosed herein are merely representative, yet in that regard, they are deemed to afford the best embodiment for purposes of disclosure and to provide a basis for the claims herein which define the scope of the present principles.

Some elements of the present principles are illustrated as modules for performing described functions. While these modules may be described in terms of software implementations, any hardware, or combination of hardware and software may be used to implement the present principles without deviating from the scope or spirit thereof.

Moreover, well known methods and procedures for both carrying out the objectives of the present principles and illustrating the preferred embodiment are incorporated herein but have not been described in detail as not to unnecessarily obscure novel aspects of the present principles.

It will be appreciated that although the remote moisture monitoring system description is described as used in a remote installation system, the present principles are not limited to such use. For instance, the principles could be used in any other businesses or enterprises where remote equipment moisture exposure is desired. This monitoring system may include cargo, transportation, storage or warehouse units, electronics manufacturing or installation facilities, food storage or manufacturing facilities, or any other facility, enclosure or container where an ongoing humidity monitoring system is desired. While the foregoing embodiments of the principles have been set forth in considerable detail for the purposes of making a complete disclosure of the principles, it will be apparent to those of skill in the art that numerous changes may be made to such features without departing from the spirit and the scope of the present principles.

The present invention is directed to providing a remote humidity and moisture monitoring system having a remote sensing platform. The system is achieved primarily by separating the mechanism for determining the humidity and the mechanism for reporting the humidity to a central monitoring station. By separating the humidity reading apparatus form the reporting apparatus, the two different components can be selectively and separately exposed to humidity. For example, the humidity sensing component may be exposed to the monitored environment so that a humidity reading may be taken. Conversely, the system for transmitting the humidity data reading may be sealed from the environment to prolong the life of the electrical system and electronic components performing the transmission.

In one useful embodiment, a sealed electrical monitor component would be able to monitor some separate indicator component whose degradation would not affect the electrical system. One method for accomplishing such a separation of humidity monitoring and reporting may be to have a sealed video system that can observe color changes in a desiccant. Alternatively, changes in the capacitance or inductance in a chemical humidity indicator may be determined by sealed electrodes outside of a chemical monitor evaluating the chemical indicator's reactivity to an electric field. For example, two coupled inductors with a chemical humidity monitor core may detect a change in the permeability of the chemical core by monitoring the voltage induced in one coil from a voltage applied to the other coil. Similarly, a chemical humidity indicator may be disposed between two plates in a capacitor fashion, with the chemical humidity monitor changing its dielectric constant (or permittivity). Alternatively, a humidity monitor may detect a change in weight, reflectance, shape or other physical property of a humidity indicator.

While the present principles are described in terms of a video monitoring system transmitting images of a desiccant, any humidity indicator separate from a sealed monitor may be implemented without deviating from the spirit and teachings of the present principles. Furthermore, reference to video data or video monitoring is meant to encompass form high speed or full motion video to still photography. Thus, the video data may be gathered any frame rate without deviating from the principles disclosed herein.

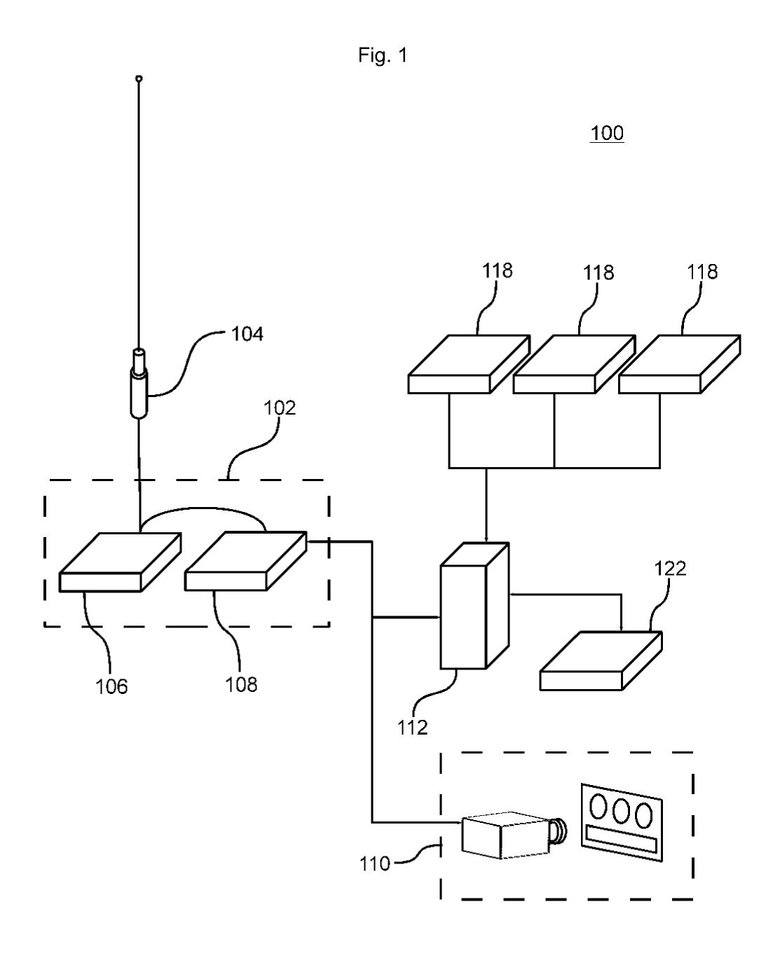

FIG. 1 illustrates an installation for a remote station 100 with remote humidity exposure monitoring. A primary module 102 is comprised of components for maintaining and operating a remote radio installation 100. One or more secondary modules 118 may also be used to provide data to the primary module 102. The primary module may, in particularly useful embodiments, have an antenna 104 for wirelessly transmitting and/or receiving data. While an antenna 104 is shown, the remote station 100 may also transmit data via a wireline or fiber optic system, terrestrial radio, satellite radio, or an other data transmission system known or as yet undiscovered. While folded monopole antennas are commonly used for their advantageous robustness and transmission efficiency, any form of antenna may be used depending on the installation designs. Antennas 104 are generally installed without physical protection from the elements, and will ideally be sealed to exposure. Additionally, any of the antennas 104, protective structures or enclosures may be grounded to protect the system against lightning strikes, static, short circuits, or any other electrical damage. For example, antennas may commonly be grounded with a gas polyphasor grounding rod to handle lightning strikes and protect the transmission equipment and associated electrical components.

The primary module 102 may also comprise a transceiver module 106 connected to the antenna 104 and for performing the actual transmission or reception of data via the antenna 104. While any frequency may be used for data exchange, the 150-200 MHz band may be particularly advantageous because of that frequency range's ability to punch through foliage, canopy, dust and other physical interferences. However, while the 150-200 MHz band provides a robust transmission frequency, it is bandwidth limited, and so skilled artisans will recognize that higher frequency bands such as 900 MHz up through 2.4 GHz provide higher bandwidth at the cost of signal robustness.

The transceiver module 106 is also connected to a modem 108 in the primary module 102 for handling incoming and outgoing data streams by multiplexing or demultiplexing transmissions. The modem 108 may, in turn be connected to an installation computer module 112 of the primary module 102. The transceiver 106, modem 108 and installation computer 112 modules may advantageously integrated into a single module, or may be installed as one or more separate modules. The modem 108 and/or transceiver may be designed to work in duplex mode for both transmitting and receiving data, or in half-duplex mode, only transmitting or receiving data. Radio modems, such as the RACOM™ MX400, are an example of combined transceiver/modem 106/108 units. Additionally, the transceiver/modem 106/108 may have capabilities for handling the overhead related to communications, such as repeaters for creating a mesh network, or for handling mobile communications repeating and/or termination into a communications network.

A monitoring module 110 may also be part of the primary module 102, and may be connected to the installation computer 112 to provide data relating to the humidity exposure of the remote station 100. In a remote station 100 using video humidity monitoring, the monitoring module 110 may be comprised of a video camera 114 trained on a humidity indicator 116 and transmitting one or more images to the installation computer module 112. The camera 114 video data may then be transmitted to the modem 108 where it is modified into a signal appropriate for transmission, and then to the transceiver 106 where video data is transmitted via the antenna 104 to a base station.

The remote station 100 may also have one or more secondary modules 118 that collect, receive, process or generate data for exchange by the primary module 102. In some installations, environmental sensors may be disposed outside of the remote station 100 installation enclosure. Secondary modules 118 may also include repeaters for creating mesh networks among remote stations 100, or as a voice transmission repeater for handling voice connections from mobile or remote communications devices. Sensor secondary modules 118 may also be configured to read or generate any form of data. In particularly useful embodiments, the remote station 100 may be configured to act as a local hub for numerous sensors that may communicate with the installation computer module 112 via a wireless connection through the primary module 102. Those sensors may be for detecting rainfall, seismic events, water levels for dams, rivers, ponds and the like, temperature, wind speed, barometric pressure, detecting motion, video, sound, or generating any kind of data for recordation or transmission to a central monitoring station 300. Sensors may also be used for analysis of environmental factors such as biological components in soil or water, salinity or chemical concentrations, environmental contamination, radiation levels, or the like. Additionally, sensors may be deployed for security purposes to allow sound, motion and/or video monitoring inside or outside of the remote station 100, or to monitor tampering with electrical components, enclosures, power systems, or any other electrical component. For example, security sensors may include a tampering monitor to determine if an enclosure is open or closed, or a security seal has been broken.

The installation computer module 112 may also handle the aggregation and bundling of data from secondary modules 118 or the monitoring module 110. For example, the installation computer module 112 may gather continuous sensor data or take one or more sensor readings from sensor secondary modules 118 over a fixed period of time. The installation computer module 112 may also make one or more remote station 100 humidity readings over the fixed period of time and may transmit the data for multiple the sensor and humidity readings to a central monitoring station 300. In one advantageous embodiment, the installation computer module 112 may automatically take sensor 118 or monitoring module 110 readings at fixed intervals, and may transmit each set of readings, or may take multiple sets of readings and transmits readings from more than one fixed interval at once.

The installation computer module 112 may also respond to incoming communications, from either a central monitoring station 300, or any other selected source. For security purposes, it may be advantageous to encrypt or secure outbound communications and allow or respond only to encrypted or authorized inbound communications. The communications may be any command or control for managing or controlling any element of the remote station 100. This may, for example, permit a user to remotely turn off, turn on, reset, move or control an individual sensor or component. In one embodiment, the inbound communications may be a request from a central monitoring station 300 for the remote station 100 installation computer module 112 to return a diagnostic report. In that particular embodiment, the remote station 100 may respond by running a diagnostic to check the status of one or more components at the time of the request and transmit that data to the central monitoring station 300, or to report archived or saved diagnostic data. The diagnostic data may include an inventory of sensors and their status and any set of archived data. Alternatively, the inbound communications may command the installation computer module 112 to take a live set of sensor 118 or monitoring module 110 readings and transmit the readings, or to transmit any archived readings.

Alternatively, the inbound communication may be a command to collect data, where the installation computer module 112 may collect secondary module 118 data or humidity data from a monitoring module 110 and transmit the collected data to the central monitoring station 300. Such an embodiment may also allow a user at the central monitoring station 300 to read stored data from the remote station and/or view live data from the remote station 100. Thus, a user may review or monitor periodic readings of data at the central monitoring station 300, and if a reading is unusual or out of tolerance, the user may activate a live data feed from the remote station 100 to assess the live situation at that remote station 100 without an actual visit. In one particularly useful example, unusual temperature or atmospheric readings may indicate a nearby fire, and a user may activate a live video feed showing the area around a remote station 100, or any other area where a camera sensor is installed. In another embodiment, the indication of motion along a road or other monitored area may indicate unauthorized persons and a live video feed may be activated to inspect monitor activity at the monitored area.

Electrical power may be provided to the remote station 100 by any known or as yet undiscovered means. Remote stations 100 may be powered by hardline power transmission such as standard AC power or power over Ethernet. The remote station 100 may be powered alternatively by, or on combination with, station-based power sources such as combustion generators, solar panels, wind turbines, or the like. Battery banks may also be used to store power derived from intermittent sources such as solar or wind. Additionally, a station-based power generation facility will ideally be ruggedized to lengthen the usable lifespan of the power generation equipment. Ruggedization may include overcapacity to compensate for later degradation of power generation efficiency while still providing a base level of power, or physical enhancements to the equipment, such as shields on solar cells. Additionally, batteries tend to lose their capacity for holding a charge and delivering adequate voltage over time and when exposed to extreme temperatures, and so the power generation and storage system may be provided with excess battery capacity to compensate for aging or temperature degradation of the batteries.

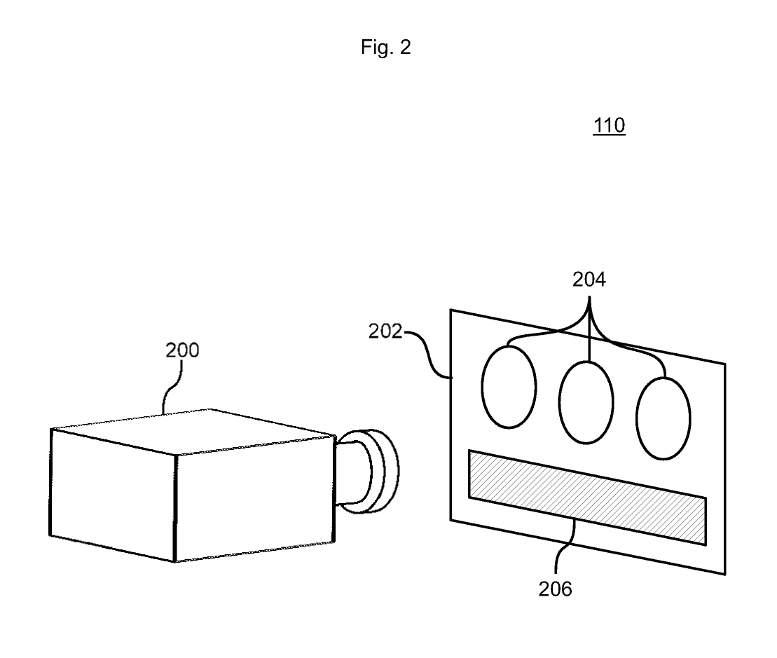

Referring no to FIG. 2, a diagram of a monitoring module 110 is shown. In the embodiment of a video monitoring module 110 shown herein, a camera 200 may be trained on a visual humidity indicator 202. In one useful embodiment, the visual humidity indicator 202 may have one or more desiccant indicators 204 disposed at the visual humidity indicator 202. In such an embodiment, any desiccant indicator 204 that may visually indicate a humidity level may be used. For example, silica gel, charcoal, calcium sulfate, copper sulfate, calcium chloride or anhydrous cobalt chloride may be used.

The camera 200 may be arranged to take video data as still images or motion video at any frame rate desired and that video data may be of the visual humidity indicator 202 and the desiccant indicators 204 therein. Additionally, the camera 200 may take the video data in color or in black and white (grayscale). Taking color video data permits more accurate assessment of any color change in the desiccant. Alternatively, taking grayscale video data requires less bandwidth for transmission of the video data to the central monitoring station 300. Ideally, a color changing desiccant used in conjunction with any video camera 200 will have a high contrast during the transition from dry to saturated.

Any number of advantageous modifications may be made to the monitoring module 110 to enhance the usability of the video data generated by the module 110. For example, the monitoring module 110 may include lights that illuminate the visual humidity indicator 202 to provide adequate or consistent lighting for the camera when the camera 200 is taking video. Alternatively, the visual humidity indicator 202 may, for example, have a visual comparison indicator 206 printed on the face of the visual humidity indicator 202 so that a viewer may accurately compare the color of the desiccant indicator 204 to the comparison indicator 206. Such visual comparison indicator 206 may permit the user to account for distortions in the video or conditions that may render the video data imperfect, such as poor or unusual lighting conditions. In one useful embodiment, the camera lens may also have a filter to filter out undesired wavelengths of light. For example, a monitoring module 110 using a cobalt chloride desiccant, which turns from blue to purple to pink as it saturates, may have a lens filter for blocking red light. This filter may allow the camera 200 to gather video data showing the desiccant's color as changing from blue to white, giving the resulting video data a higher contrast and making the humidity indication easier to read.

The visual humidity indicator 206 may also include one or more “registration marks”, or marks printed at a predetermined location and orientation so that automated systems for analyzing video may have a reference point for determining the alignment and location of elements shown in a video frame. Thus, an automated system may analyze video data for such registration marks and use the location of those registration marks as a reference for determining where data for the desiccant indicator 204 or visual comparison indicator 206 is located within the video frame.

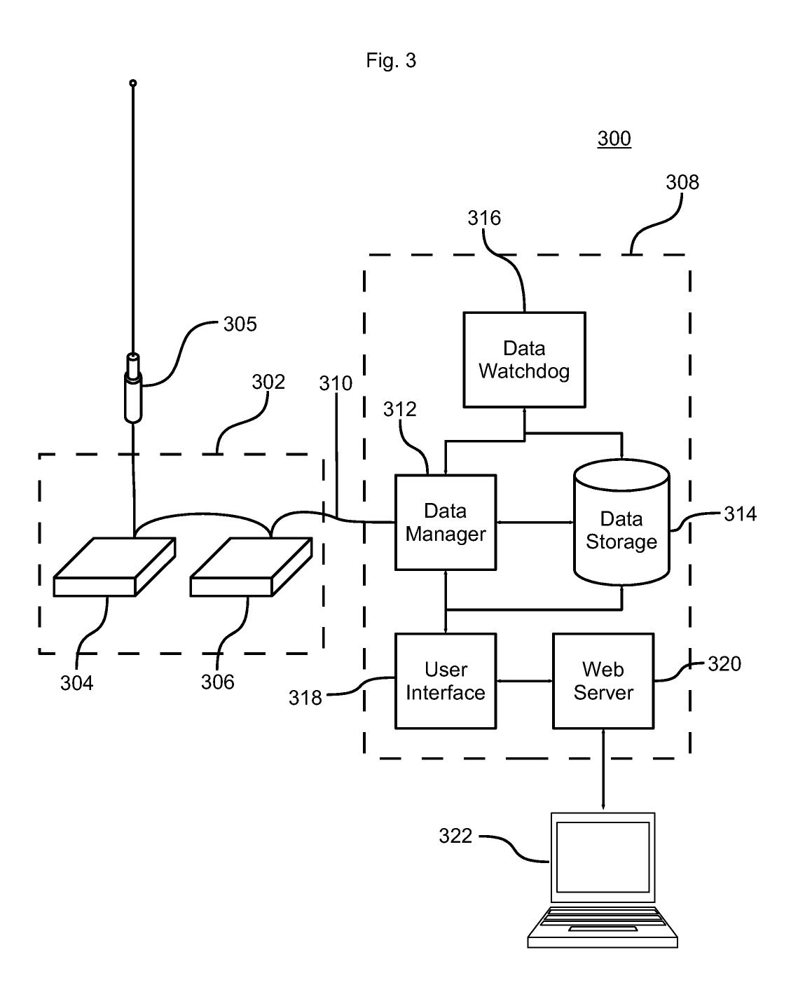

Referring to FIG. 3, a central monitoring station 300 system for handling and analyzing humidity data from a plurality of remote stations 100 is shown. The communications module 302 may have one or more components for handling receiving and/or transmitting data signals. The data handling module 308 may have one or more components for handling, storing, analyzing and/or transmitting data.

The communications module 302 may advantageously have a transceiver 304 for transmitting and/or receiving data from at least one remote station 100. In embodiments where the remote stations 100 all communicate with the central monitoring station 300 wirelessly, the transceiver 304 may use one or more antennas 305 for communication. However, a wireline system may be used in place of, or in conjunction with, the antenna 305 to communicate with one or more remote stations 100. Additionally, the transceiver 304 may be configured to receive or transmit data other than humidity monitoring data. For example, the transceiver 304 may receive humidity monitoring data from remote stations 100, but may also receive additional sensor or communications data from the remote stations 100. Thus, a central monitoring station 300 may receive various kinds of environmental data from the remote station 100 sensors 118 and also receive data on the humidity within the remote station 100 enclosure.

The data management module 308 may be in signal communication with the components of the communications module 302. The data management module 308 is configured to handle data after it is received by the communications module 302. Additionally, the data management module 308 may generate or pass along commands or data to one or more remote stations 100. The data management module 308 may be comprised of a data handling module 312 configured to handle the movement and storage of data within the data management module 308. The data management module 308 receives and queues incoming data for storage by the data storage module 314. The data management module 308 may also be used to control or manage one or more components at any remote station. The data management module 308 may poll remote stations 100, or handle registration messages from newly installed remote stations 100.

A data watchdog 316 may also be in signal communication with the data handling module 312. The data watchdog 316 may also access the data storage module 314, either directly or through the data handling module 312. The data watchdog 316 is configured to analyze data coming through the data handling module 312 or data stored in the data storage module 314, or any combination of data from the data sources, the data handling module 312 and data storage module. The data handling module 312 may further comprise a user interface module 324 and a web server 320 for providing a user interface to a remote terminal 322. The remote terminal 322 may be at the central monitoring station 300, or located at any other location with communications facilities permitting the remote terminal 322 to exchange data with the web server 320.

On one embodiment, the user interface module 324 may fetch data from the data storage module 314 and generate one or more web pages for transmission by the web server 320 to a remote terminal 322. The user interface module 324 may also show live data being transmitted from one or more remote stations, or any combination of stored and live data. Such an embodiment may permit a user to monitor the stored humidity readings for one or more remote stations 100, or view any report or aggregation of remote sensor and/or humidity data. For example, a user may wish to view a report of any humidity readings or accumulated humidity values that exceed that related station's threshold or a predetermined threshold, permitting a user to anticipate when remote station 100 equipment needs servicing, or when some other problem occurs. Thus, at a remote station 100 disposed in a heavily wooded area, an unexpected rise in average humidity values at a particular station may indicate that a ventilation system has become clogged with debris, or that an animal has interfered with the ventilation system by building a nest in a vent. Alternatively, a sealed enclosure's humidity may be monitored to versify that a seal has not been breached.

The user interface module 324 may also be used to control one or more remote stations 100 individually, or as a group. Thus, a user at a remote terminal 322 may use the user interface module 324 to command a selected group of remote stations to run diagnostic utilities, and then collect and display the resulting data. Alternatively, the user interface module may present an interface to user at a remote terminal for controlling any sensor or component at one or more remote stations 100. In such an embodiment, the user may command a sensor 118 or set of sensors 118 at a remote station 100 to take new sensor readings, transmit any archived data and/or transmit live data.

In yet another embodiment of the present principles, a plurality of remote stations 100 may be in communication with a substation, which may communicate with the central monitoring station 300. This communication from the substation to the central monitoring station 300 may be direct, or through another remote station 100 or substation. Any number of substations may also be deployed, each having any number of other substations or remote stations 100 in communication. Repeaters at substations and/or remote stations 100 maybe used to retransmit data from other stations. Thus, a network of substations and remote stations 100 may be deployed to extend the practical monitoring range of a central monitoring station 300. The communication links between a remote station 100 and substations, between substations, between a remote station 100 and a central monitoring station 300 or between a substation and a central monitoring station 300 may be any combination of wireless, wireline, fiber optic or any other type of communications link known or as yet undiscovered.

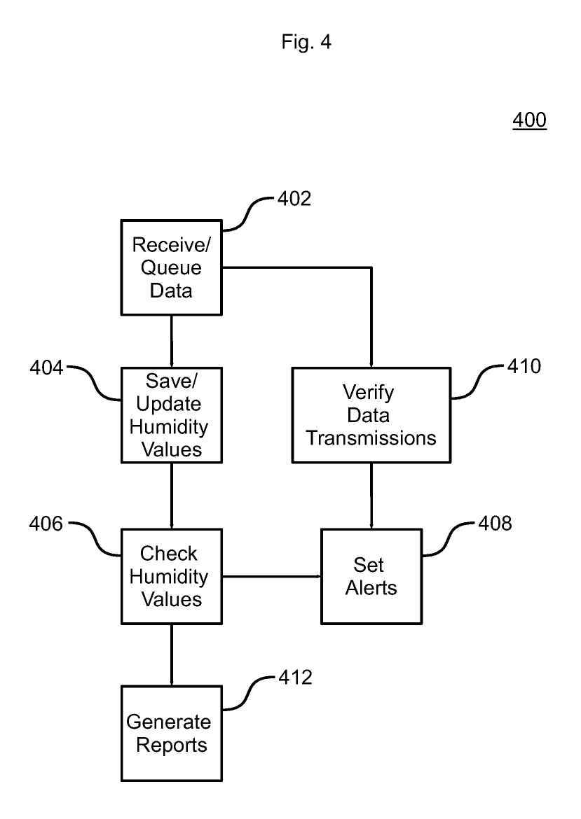

Referring now to FIG. 4, a diagram illustrating the process for the data management module 308 handling data exchange is shown. The data handling module 308 receives data from the communications module 302 in block 402. Upon receipt of data from the communications module 302, the data handling module 308 examines a data transmission to determine what action to take on that data. Environmental data and humidity monitoring data may be stored in the data storage module 314. For example, remote station 100 humidity data may be stored with relation to the remote station 100 from which the humidity data was obtained. In one embodiment, the remote station humidity data may be identified by data transmitted with the remote station humidity data. In another embodiment, the humidity data may be transmitted as video data, and the identifying information may be included as part of the video data, such as a time stamp or as EXIF data. Remote station 100 humidity data may also be used to calculate an overall humidity exposure for the remote station 100.

The remote station humidity data may be stored in block 404 as raw data, for example by storing the video data on a storage server and storing a reference to the location in the data storage module 312 or by storing the raw data in the data storage module 312 itself. Thus, a reference to the data and an identifier to the relevant remote station may be stored, and may be retrieved at later for review to verify that the humidity has not exceeded a critical threshold.

Alternatively, the data handling module 312 may include software, or any other mechanism, for identifying color changes by the desiccant at the remote station 100. The data handling module 312 may search the video data for data at particular locations in a frame and associate a video data section from that frame location with the desiccants at the remote location 100. In such an instance, the software may determine the orientation of the humidity indicator video data from a registration mark in the video data. Such determination may be made by referencing a known location with respect to the registration mark. The color of the video data section from the particular frame locations may be used to calculate the humidity inside the remote location at the time the video data was captured. The video data section may be compared to a known scale of color information to determine the humidity in the remote station 100 at the time the video data was taken. For example, a hexadecimal value for a particular pixel, or an average pixel color for a video data section may be light gray, or #BBBBBB, which is roughly 70% white and 30% black. Thus, when using a grayscale comparison, the humidity might be determined to be 30%. Alternatively, the same video data value may be calculated as indicating 50% humidity when using a predetermined scale that identifies that particular data value to be within the range for a 50% humidity value.

In another useful embodiment, the video data may also include a visual comparison indicator 206, and the data handling module 312 may sample data from a predetermined location in the video frame to use as the known scale for color information comparison. This particular embodiment has the advantage of compensating for adverse or atypical lighting conditions, permitting the data handling module 312 to more accurately determine the condition or color of a desiccant by comparing the values from the visual comparison chart 206 video data to the video section data of the desiccant. Any adverse conditions affecting the video data and accurate determination of the color of a desiccant may be mitigated because those adverse conditions will affect the visual comparison chart 206 as well.

Alternatively, the humidity value may be calculated from the visual representation of the video data by the remote station 100 installation computer module 112, which may then transmit the humidity value to the data handling module 312.

In one embodiment, the data handling module 312 may, in block 404, save a determined humidity value in the data storage module 314. In an alternative embodiment, the data handling module 312 may also load an accumulated humidity value and add the latest determined humidity value to the total to update the accumulated humidity exposure value. In yet another embodiment, the accumulated humidity value may be determined by integrating the humidity values taken for some period of time.

The data watchdog 316 may, in block 406, determine whether the determined humidity value has exceeded a predetermined threshold, and/or whether the accumulated humidity exposure was exceeded a predetermined threshold. Upon determination that a threshold has been exceeded, the data watchdog 316 may set an alert in block 408. The alert may be an entry in the data storage module 314, or it may be an email, text message, voice message, or any other communication alerting one or more parties that a remote station 100 has exceeded its accumulated humidity exposure limits or has passed some threshold for humidity readings once or for any predetermined or advantageous period of time.

The data watchdog 318 may also generate reports in block 412 on remote stations 100 where the moisture exposure has exceeded a predetermined threshold. The predetermined threshold for remote stations 100 to be added to the report for the data watchdog 318 may be stored in or loaded from the data storage module 314 or may be stored and loaded from any accessible location. Similarly, the thresholds for the determined humidity value and/or accumulate humidity exposure may also be stored in or loaded from the data storage module 314 or from any accessible location.

Alternatively, the data watchdog 316 may monitor incoming transmissions to verify that a set of expected transmissions has been received in block 410. In this embodiment, a data watchdog 316 may expect that each of a group of remote stations 100 will transmit sensor data and humidity data for example, every fifteen minutes, and when a station fails to make a proper report, or fails to make a report for any specified number of reporting periods, the data watchdog 316 may set an alert that that remote station 100 has failed. Similarly, the data watchdog 316 may monitor incoming reports from remote stations 100 and verify that each report has data from each sensor in a group of sensors 118 at each remote station 100, with any missing sensor data sets indicating failure of a particular sensor 118 and where the data watchdog 316 may set an alert.

Thus, the present principles as described herein enable an artisan skilled in sensor networks to make and use a system for remote monitoring of equipment humidity exposure.

I claim:

1. An apparatus for monitoring humidity exposure of system components in an enclosure, the apparatus comprising:
at least one sensor module disposed outside of the enclosure and configured to collect data from the environment outside of the enclosure;
at least one monitoring module comprising at least one humidity indicator and at least one electrical monitor component, wherein the at least one humidity indicator is exposed to an enclosure environment affecting at least one system component within the enclosure and configured to indicate a humidity value for the enclosure environment via a physical change and wherein the at least one electrical monitor component is protected from the environment and is configured to read a physical value of the humidity indicator to generate at least one humidity indication data indicating the humidity of the enclosure environment; and
an installation computer module disposed within the enclosure and in signal communication with the at least one sensor module and in signal communication with the at least one electrical monitor component of at least one monitoring module;
wherein the installation computer is configured to receive the environment data from at least one sensor module, and is further configured to receive data from the at least one electrical monitor indicating the humidity of the environment; and
wherein the installation computer module is configured to cause the transmission of the humidity data and environment data to a central monitoring station.

2. The apparatus of claim 1, wherein at least one humidity indicator comprises a desiccant capable of changing colors depending on the humidity of the enclosure environment, and wherein at least one electrical monitor component is a camera configured to take video data of the humidity indicator and wherein the camera generates at least one humidity indication data as video data, and wherein the video humidity indication data shows a visual representation of the humidity indicator.

3. The apparatus of claim 2, wherein the at least one humidity indicator further comprises a visual comparison indicator disposed thereon and having at least one printed area showing at least one possible desiccant color value and wherein the visual comparison indicator is disposed on the humidity indicator so that the video humidity indication data comprises a visual representation of the visual comparison indicator.

4. The apparatus of claim 2, wherein the at least one humidity indicator further comprises at least one registration mark disposed at a predetermined location on the humidity indicator, and wherein the desiccant is disposed on the at least one humidity indicator in a predetermined location relative to the registration mark.

5. The apparatus of claim 1, wherein the installation computer module is configured to automatically collect humidity data from at least one electrical monitor at predetermined intervals.

6. The apparatus of claim 1, wherein the installation computer module is configured to receive commands from a remote location, wherein the installation computer module is configured to collect data from at least one sensor module in response to the command.

7. The apparatus of claim 1, wherein at least one sensor modules is a sensor configured for performing one or more functions from a group consisting of measuring rainfall, measuring a seismic event, measuring a water level, measuring temperature, measuring wind speed, measuring barometric pressure, detecting motion, generating environmental video data, generating environmental sound data, measuring biological components, measuring salinity, measuring chemical concentrations, measuring environmental contamination, measuring a radiation level, and detecting tampering system components.

8. An apparatus for monitoring humidity exposure of system components, the apparatus comprising:
a modem configured to handle at least one communication data stream;
at least one monitoring module comprising at least one humidity indicator and at least one electrical monitor component, wherein the at least one humidity indicator is exposed to an environment affecting at least one system component and configured to indicate a humidity value for the environment via a physical change and wherein the at least one electrical monitor component is protected from the environment and is configured to read a physical value of the humidity indicator to generate at least one humidity indication data indicating the humidity of the environment; and
an installation computer module in signal communication with the electrical monitor component of the at least one monitoring module, and configured to receive the at least one humidity indication data from the at least one electrical monitor;
wherein the installation computer module is in signal communication with the modem and configured to transmit the humidity data to the modem; and
wherein the modem is configured to transmit the humidity data to a central monitoring station.

9. The apparatus of claim 8, wherein at least one humidity indicator comprises a desiccant capable of changing colors depending on the humidity of the environment, and wherein at least one electrical monitor component is a camera configured to take video data of the humidity indicator and wherein the camera generates at least one humidity indication data as video data, and wherein the video humidity indication data shows a visual representation of the humidity indicator.

10. The apparatus of claim 9, wherein the at least one humidity indicator further comprises a visual comparison indicator disposed thereon and having at least one printed area showing at least one possible desiccant color value and wherein the visual comparison indicator is disposed on the humidity indicator so that the video humidity indication comprises a visual representation of the visual comparison indicator.

11. The apparatus of claim 10, wherein electrical monitor component further comprises at least one light source configured to illuminate the at least one humidity indicator.

12. The apparatus of claim 11, wherein the camera comprises a filter configured to block at least one predetermined range of light wavelengths.

13. The apparatus of claim 9 further comprising at least one sensor module configured to collect data, and wherein the installation computer module is configured to receive commands from a remote location, wherein the installation computer module is configured to collect data from at least one sensor module in response to the command.

14. The apparatus of claim 9 further comprising at least one sensor module configured to collect data, and wherein the installation computer module is configured to automatically collect data from at least one sensor module at predetermined intervals.

15. The apparatus of claim 9, further comprising a sealed antenna in signal communication with the modem, and wherein the modem is a radio modem and is configured to wirelessly transmit the humidity data via the antenna.

16. An apparatus for monitoring humidity exposure of system components in an enclosure, the apparatus comprising:
a modem configured to handle at least one communications data stream;
at least one sensor module disposed outside of the enclosure and configured to collect data from the environment outside of the enclosure;
at least one monitoring module comprising at least one humidity indicator and at least one electrical monitor component, wherein the at least one humidity indicator is exposed to an enclosure environment affecting at least one system component within the enclosure and configured to indicate a humidity value for the enclosure environment via a physical change and wherein the at least one electrical monitor component is protected from the environment and is configured to read a physical value of the humidity indicator to generate at least one humidity indication data indicating the humidity of the enclosure environment; and
an installation computer module disposed within the enclosure and in signal communication with the at least one sensor module and in signal communication with the at least one electrical monitor component of the at least one monitoring module;
wherein the installation computer is configured to receive the environment data from at least one sensor module, and is further configured to receive data from the at least one electrical monitor indicating the humidity of the environment;
wherein the installation computer module is in signal communication with the modem and configured to transmit the humidity data to the modem; and
wherein the modem is configured to transmit the humidity data to a central monitoring station.

17. The apparatus of claim 16, wherein the installation computer module is configured to receive commands from a remote location, wherein the installation computer module is configured to collect data from at least one sensor module in response to the command.

18. The apparatus of claim 16, wherein the installation computer module is configured to automatically collect data from at least one sensor module at predetermined intervals.

19. The apparatus of claim 16, wherein the installation computer module is configured to automatically collect data from at least one sensor module and store two or more sensor data.

20. The apparatus of claim 16, wherein the installation computer module is configured to automatically collect humidity data at predetermined intervals.
